(19) United States
(12) Patent Application Publication
(10) Pub. No.: US 2008/0075866 A1
(43) Pub. Date: Mar. 27, 2008

(54) Method for low temperature densification of ceramic materials

(76) Inventors: Vladimir Petrovsky, Rolla, MO (US); Tatiana Petrovsky, Rolla, MO (US); Harlan Anderson, Rolla, MO (US)

Correspondence Address: KENYON & KENYON LLP, ONE BROADWAY, NEW YORK, NY, 10004, US

(21) Appl. No.: 11/150,675

(22) Filed: Jun. 9, 2005

(51) Int. Cl. B05D 3/02

(52) U.S. Cl. 427/376.1

(57) ABSTRACT

The present invention provides methods for the preparation of ceramic materials. Using the methods of the present invention, a porous ceramic material is impregnated with a metal-organic polymer and then treated with heat to decompose the polymer. Advantageously, the heat treatment may be performed at low temperature. The methods of the invention can be used to increase the density of a porous ceramic material or to change its composition. The methods are particularly useful for the formation of ceramic products in the form of films, coatings and layers in multilayer ceramic systems.

### STATEMENT REGARDING FEDERALLY SPONSORED RESEARCH OR DEVELOPMENT

The subject matter presented in this patent application was funded in part by the United States Department of Energy (DOE) under Grant Number DE-AC26-99FT40710. The Government may have certain rights in this invention.

### FIELD OF THE INVENTION

The present invention relates to a method for the preparation of ceramic materials. More specifically, the present invention relates to a method of densification of a porous ceramic material. The present invention also relates to a method for the preparation of composite ceramic materials. The present invention further relates to the preparation of metal oxide thin films.

### BACKGROUND

Ceramic materials are commonly prepared from metal oxide powders, such as zirconia, ceria, titania, and alumina using a variety of methods including tape casting, screen printing, spinning, dipping or spraying. Each of these methods go through what is referred to as “green ceramic.” At this stage, the aggregate structure of the ceramic material is formed, but the porosity of the material is high, ranging from about 30% to about 50%, and the connection between the particles in the material is poor. Green ceramic is subjected to treatment with high heat (generally ½ to ¾ of the melting point) in a process known as sintering to convert the green ceramic into a cohesive “fired ceramic” having a nearly monolithic polycrystalline phase. The disadvantage of this process is the necessity of a high heat treatment to densify the green ceramic. Additionally, shrinkage typically occurs during the sintering process. Using this process, it is difficult to control the porosity of the final material.

Metal oxide films can be prepared according to the process of Anderson et al. in U.S. Pat. No. 5,494,700. Metal-organic polymers can be deposited as thin, continuous coatings on solid substrates using spin on deposition, dip coating or spraying, and thereafter converted to a dense amorphous or nanocrystalline metal oxide film by decomposing the organic content of the polymer at temperatures as low as 200 to 400° C. The films of various metal oxides can be prepared by this technique. However, this technique results in coatings of relatively low thickness, ranging from about 30 to 300 nm for one deposition. Additionally, the films suffer from shrinkage at the transition from the polymeric phase to the metal oxide phase, which can cause cracking of thicker coatings (referred to herein as the “cracking limit”).

Chen et al. in U.S. Pat. No. 6,165,553 and Barrow et al. in U.S. Pat. No. 5,585,136 attempt to overcome this limitation by mixing the ceramic powder with a metal-organic polymer or with sol-gel precursor. Using these approaches, the metal-organic polymer or sol-gel precursor can connect the powder particles and improve the mechanical properties of the green ceramic. However, this approach has limited application in the preparation of dense ceramic materials or materials with controlled porosity and composition. It is not possible to load the slurry by more than about 50 vol. % of the polymer. Cracking will occur at the decomposition stage of the process because of shrinkage (similar to the polymeric coatings). At the same time, the metal oxide content in the polymer is limited (usually less than about 20 vol. %), so that the final density of the ceramic material will be no more than 20% higher than the density of the green ceramic prepared without the polymer.

### SUMMARY OF THE INVENTION

The present invention provides a method for the preparation of ceramic materials. Particularly, the invention is directed to a method for the densification of a porous metal oxide ceramic material by treating the porous metal oxide ceramic material with a solution of a metal-organic polymer, wherein the solution of a metal-organic polymer comprises from about 2 to about 20 percent by volume of the solution of a metal oxide having the same composition as the porous metal oxide ceramic material, and heating the treated porous metal oxide ceramic material at a temperature of about 200° C. to about 800° C. to yield a densified metal oxide ceramic material.

The present invention also provides a method for the preparation of a composite ceramic material by treating a porous metal oxide ceramic material with a solution of a metal-organic polymer wherein the solution comprises from about 2 to about 20 percent by volume of the solution of a metal oxide having a different composition than the porous metal oxide ceramic material, and heating the treated porous metal oxide ceramic material at a temperature of about 200° C. to about 800° C. to yield a composite metal oxide ceramic material.

The present invention also provides a method of preparing a metal oxide thin film on a substrate by applying a suspension of a powdered metal oxide to a substrate to give a layer of the metal oxide, treating the layer of the metal oxide with a solution of a metal-organic polymer, and heat treating at a temperature of about 200° C. to about 800° C. to give the metal oxide thin film.

### BRIEF DESCRIPTION OF THE FIGURES

FIG. 1 shows the dependence of the relative density (in percent) on the number of applications, n, of the process of the invention. The results presented in the figure were calculated using equation (5) assuming that an initial relative density do equals 50% for different volume fractions of metal oxide in the metal-organic polymer.

### DETAILED DESCRIPTION

The present invention provides methods for the preparation of ceramic materials. Using the methods of the present invention, a porous ceramic material is impregnated with a metal-organic polymer and then treated with heat to decompose the polymer. Advantageously, the heat treatment may be performed at low temperature. The methods of the invention can be used to increase the density of a porous ceramic material or to change its composition. The methods are particularly useful for the formation of ceramic products in the form of films, coatings and layers in multilayer ceramic systems. Such systems include, for example, ceramic gas separation membranes, solid oxide fuel cells and ceramic capacitors.

In one embodiment, the invention is directed to a method for the densification of a porous metal oxide ceramic material by treating the porous metal oxide ceramic material with a solution of a metal-organic polymer and heating the treated porous metal oxide ceramic material at a temperature of less than about 1000° C. to yield a densified metal oxide ceramic material. The solution of the metal-organic polymer comprises from about 2 to about 20 percent by volume of the solution of a metal oxide having the same composition as the porous metal oxide ceramic material. The resulting densified ceramic materials have increased strength and density when compared to the initial porous ceramic material. The density of the final ceramic material can be controlled by changing the concentration of the metal oxide in the metal-organic polymer solution or by using multiple applications of the process of the invention.

In another embodiment, the invention is directed to a method for the preparation of a composite ceramic material by treating a porous metal oxide ceramic material with a solution of a metal-organic polymer having from about 2 to about 20 percent by volume of the solution of a metal oxide having a different composition than the porous metal oxide ceramic material and heating the treated porous metal oxide ceramic material, preferably at temperature of about 200° C. to about 800° C., to yield a composite metal oxide ceramic material. The composition and density of the final ceramic material can be controlled by adjusting the composition and concentration of the metal oxide in the metal-organic polymer solution or by using multiple applications of the process of the invention.

In a further embodiment of the invention, a colloidal suspension of a powdered metal oxide is initially prepared. The colloidal suspension comprises powdered metal oxide and solvent. The colloidal suspension is applied to a target, for example by spin coating to give a thin film. The target may be a dense or porous substrate. The coating is dried and heated to a temperature sufficient for bonding to the surface. The layer formed is further treated with one or more applications of a solution of metal organic polymer with subsequent heating to achieve the desired density or composition of the final film. The processing temperature is preferably about 200° C. to about 800° C.

The initial porous ceramic material or the initial metal oxide powder may be selected from, for example, an oxide of aluminum, silicon, zirconium, cerium, titanium, yttrium, samarium, gadolinium, lanthanum, praseodymum, calcium, chromium, manganese, iron, cobalt, nickel copper, niobium, hafnium, molybdenum, tantalum, tungsten and a mixture thereof. The metal oxide may be any combination of materials such as doped ZrO₂, doped CeO₂, Ni-cermet, a rare earth-CoO₃, a rare earth-MnO₃, a rare earth-FeO₃, or the like.

The term “porous metal oxide ceramic material” as used herein refers to any metal oxide ceramic material or precursor that is not fully dense and includes, for example green ceramic materials.

“Metal-organic polymer” as used herein refers to any organic composition which contains a metal cation, or different metal cations, incorporated in the organic composition. The metal-organic polymer provides a coating on the solid substrate or the metal oxide particles and decomposes to form an amorphous or nanocrystalline metal oxide (or metal oxides) at relatively low annealing temperatures.

Metal-organic polymers are well known materials. These materials can be prepared from metal-alkoxides, from metal salts using the process described for example in U.S. Pat. No. 5,494,700, which is incorporated herein by reference in its entirety, or by a variety of the other methods. In one embodiment, the metal-organic polymer is prepared from the corresponding metal alkoxide which is polymerized by the addition of water, ethylene glycol, or the like. Use of the metal alkoxide as the precursor results in a metal-organic polymer having a high metal content and a decomposition temperature (for example, about 200° C. to about 400° C.). However, such metal-organic polymers generally suffer from sensitivity to moisture. It is also possible to prepare metal-organic polymers from the salts of corresponding metals and use different organic materials (for example, ethylene glycol, citric acid, etc.) for substitution reactions and further polymerization. Acetates of metals are well known precursors for such processing. This processing may be advantageous as acetates of different metals are widely available, it is relatively easy to polymerize metal acetates, and the resulting metal-organic polymer are stable and not generally sensitive to moisture. In many cases, this type of polymer may be prepared as the water solution. However, these polymers typically have a lower metal content and higher decomposition temperature (from about 300° C. to about 500° C.) as compared to metal-organic polymers prepared from metal alkoxides. A preferred method for preparing the metal-organic polymer is from the elementary salt (such as nitrates, chlorates, etc.) as described in U.S. Pat. No. 5,494,700 to Anderson et al., which is incorporated herein by reference in its entirety. Although substitution and polymerization processes may be more complicated in this case, polymeric metal oxides for a series of metals may be prepared by this method. The resulting metal-organic polymers have a relatively high metal content, low decomposition temperatures and are generally water-compatible.

Metal-organic polymers can be deposited using, for example, spin on deposition, dip coating or spraying, and is thereafter converted to a dense amorphous or nanocrystalline metal oxide film by decomposing the organic content of the polymer, preferably by heating to a temperature of about 200° C. to about 800° C., although in some cases temperatures up to about 1100° C. may be used. The films of different metal oxides can be prepared by this technique including, for example, zirconia, ceria, titania, etc., as well as various metal oxide compositions including, for example, yttrium doped zirconia (YSZ), gadolinium and samarium doped ceria (GDC and SDC), barium titanate (BT), strontium titanate (ST), etc.

The solvents employed in the methods of the invention may be selected from any solvent or mixture of solvents that is compatible with the metal-organic polymer. Preferred solvents include water, alcohols (such as methanol, ethanol, butoxyethanol, and the like), and mixtures thereof. The solvent may be removed, for example by evaporating at room temperature or at an elevated temperature prior to the subsequent processing step.

The metal oxide content in the metal-organic polymer should be low enough to exclude cracking of the layer formed on the surface of the initial ceramic particles as a result of the polymer decomposition. The thickness of this layer may be defined by the volume fraction of metal oxide in the metal-organic polymer, the size and shape of metal oxide particles in the initial ceramic material and its porosity according to the following formula:

L_{cr}>L=Vₘₒ*S/6*P/(1−P)*A (1)

wherein
L_{cr} is the cracking limit for the particular metal oxide polymer or copolymer;
L is the thickness of the metal oxide layer formed as a result of metal oxide polymer
   or copolymer decomposition on the surface of initial ceramic material particles;
Vₘₒ is the volume fraction of metal oxide in the metal oxide polymer or copolymer;
S is the average size of the particles in the initial ceramic material;
P is the porosity of the initial ceramic material;
A is a numerical coefficient depending on the shape of the particles in the initial ceramic material and equals 1 for spherical particles.

Typically, the volume fraction Vₘₒ of metal oxide in the metal-organic polymers ranges from about 2 to 20% (in average 10%), the porosity of the initial ceramic material ranges from about 30 to 50% (in average about 40%) and the cracking limit ranges from 30 to 300 nm (assume 100 nm in a typical case). The average thickness of the resulting metal oxide layer L can be estimated by the formula:

L_{cr}>L˜0.1*S*/9*A (2)

Formula 2 gives the limit for the maximum size of the particles in the initial ceramic material to be S<9 μm for spherical particles (A=1) on which no cracking occurs (a particle size typically used to form sintered materials). A lower volume fraction of the metal oxide in the polymer generally is used for a larger particle size.

The metal oxide content in the metal-organic polymer should be high enough to provide an effective filling of the pores in the initial ceramic material. The efficiency of this process can be calculated by the change in the relative density of the initial ceramic material

d=100*D/D_{dense} (3)

wherein d is relative density (in percents), D and D_{dense} are absolute densities of porous and dense materials, respectively.

The value of the relative density after one application for the method of the invention can be calculated from the equation:

d₁=100−(100−d₀)*(1−Vₘₒ/100) (4)

The density obtained for multiple applications of the method of the invention is given by the equation:

dₙ=100−(100−d₀)*(1−Vₘₒ/100)^{n.} (5)

The change in the density (d₁-d₀) estimated from equation (4) for the average volume fraction of metal oxide in the polymer of 10% and initial density of 50% will be 5%. The change in the density will increase with the number of the applications of the method of the invention. For example, it will be equal to 32.6% for 10 applications of the process in accordance with equation (5).

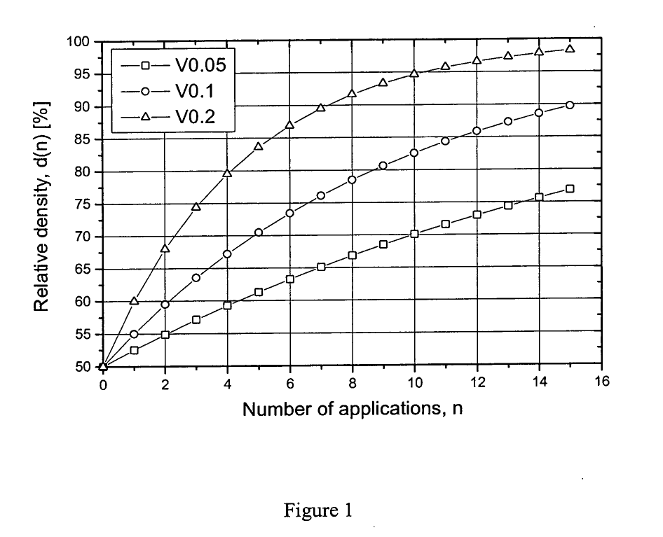

The graphical dependence of the final relative density, dₙ from the number of applications in accordance with the equation (5) is presented in FIG. 1 for different volume fractions of metal oxide in the polymer. It can be seen from the figure that the efficiency of the densification increases with the increase of the volume fraction of metal oxide in the metal-organic polymer. It is possible to densify a material that is initially 50% porous to relative density of 98% by using 15 applications of the process of the invention, if the volume fraction of metal oxide in the metal organic polymer is high (Vₘₒ=0.2).

After treatment with the metal-organic polymer, the metal-organic polymer will coat the particles of metal oxide or fill the pores between the particles in the initially porous ceramic material. The metal-organic polymer is subsequently converted into an amorphous or nanocrystalline metal oxide by decomposition of the polymer at the heat treatment stage of the process. The decomposition of the metal-organic polymer is done by heat treatment at relatively low temperature. In one embodiment, the impregnated ceramic material is heated at a temperature of about 200° C. to about 800° C. Preferably, the decomposition temperature is from about 200° C. to about 500° C., and more preferably from about 200° C. to about 400° C. The metal-organic polymer is unlikely to decompose at temperatures lower than 200° C., unless the material is concurrently treated with an additional means of assisting the decomposition, such as UV-radiation, γ-radiation, etc. Although a decomposition temperature of about 200° C. to about 400° C. is preferred, for some metal-organic polymers a decomposition temperature higher than 400° C. is needed (for example, for cross-linked organic materials). Without being limited by theory, it is believed that the low decomposition temperatures is effective because the metal oxide that is prepared has no phase transitions, so that a final stable phase can be achieved at low temperature. However, this may not hold for all materials. For titania, the decomposition temperature may be higher than about 900° C. (the transition temperature for the rutile phase) and for alumina it may be higher than 1100° C. (the transition temperature for the corundum phase). At the decomposition stage of the process an amorphous or nanocrystalline metal oxide layer forms on the particle surface. This layer increases the particle size of ceramic material and, consequently, decreases the porosity.

The present invention allows the composition and the density of the final ceramic material to be controlled by adjusting the metal oxide content in the metal-organic polymer, or by repeating the process of the invention multiple times until the desired density is achieved. Thus, the methods of the invention can be used to decrease the porosity of the initially porous ceramic material, if metal-organic polymer has the same metal oxide composition as the initial ceramic material. It also can be used to build composite materials if metal oxide compositions in the metal-organic polymer and in the initial ceramic material are different. The final porosity and the composition of the ceramic material can be controlled by changing the metal oxide content in the polymer, or by repeating proposed process for several times.

It is possible to use the final ceramic material prepared by the method of the invention as prepared without further processing. The possibility to control the density, strength and the composition of the final ceramic material at relatively low temperature is a particular advantage of the methods described herein.

It is also possible to use the final ceramic material prepared by the method of the invention as an improved green ceramic with higher density and strength. The shrinkage of this improved green ceramic will be smaller at the sintering process, which is especially important for multilayer ceramic systems. This process allows the formation of a dense structure from a partially sintered, porous perform without additional shrinkage which has an advantage when processing complex structure to desired dimensions.

### EXAMPLES

### Example 1

Cerium oxide polymer was prepared using cerium nitrate hydrate by the following procedure. Cerium nitrate hydrate (31.6 g) was dissolved in water (30.39 g) and 1.11 g of 70% nitric acid was added to the solution. Ethylene glycol (11.1 g) was mixed with the resulting solution and the mixture was heated with stirring at 70° C. for 72 hours to evaporate water and provide polymerization. The polymer weighed 14 g and appears as a viscous, slightly yellowish liquid with volume fraction of ceria equal to 17.3%. The final cerium oxide polymer solution was prepared by adding 0.7 g of butoxyethanol. The volume fraction of ceria in the final solution was 11.5%.

A green ceramic layer from YSZ powder with a grain size of 200 nm was prepared on a glass substrate by a standard tape casting technique. The layer was heated at 400° C. for 3 h to decompose and remove the organic binder. The thickness of the layer was 20 μm and the porosity was 50%. The layer appeared as a white, nontransparent coating.

The cerium oxide polymer solution was deposited on the green ceramic layer by spin coating (spinner speed 5000 rpm, spinning time 60 s) and dried at room temperature for 3 hours to evaporate the butoxyethanol. The substrate was slowly heated to 400° C. (heating speed 1°/min) to decompose the polymer and cooled to room temperature. This deposition procedure was repeated 12 times.

The final ceramic layer was semitransparent, uniform and had no cracks or separations from the substrate.

### Example 2

Ceria polymer was prepared using cerium nitrate hydrate by the procedure described in Example 1. The final cerium oxide polymer solution was prepared by adding 0.7 g of ethylene glycol. The volume fraction of ceria in the final solution was 12%.

A porous lanthanum-strontium manganese (LSM) substrate was prepared from LSM powder (average particle size 2 μm) by tape casting and sintered at 1450° C. to give a porosity of about 50%.

A slurry was prepared by mixing ceria powder (25 g) with water (50 g) and butoxyethanol (50 g). The average particle size of ceria powder was 20 nm. The slurry was homogenized by treatment using a 130 Watt ultrasonic processor VC 130 (Sonics & Materials, Inc.) for 3 hours.

The slurry was deposited on an LSM substrate by spin coating at a speed of 2000 rpm and dried at room temperature for 3 hours to evaporate the solvent. The substrate was slowly heated to 400° C. (heating speed 1°/min). This procedure was repeated 3 times and final coating was annealed at 600° C. for 3 hours.

The cerium oxide polymer solution was deposited on the surface of this coating by spin coating (spinner speed 5000 rpm, spinning time 60 s) and dried at room temperature for 3 hours to evaporate the solvent. The sample was slowly heated to 400° C. (heating speed 1° C./min) to decompose the polymer and cooled to the room temperature. This deposition procedure was repeated for 10 times. The precursor did not soak in the coating after this number of depositions and formed a continuous film on the surface of the coating.

The final layers had a thickness of 2000 nm, a smooth surface, with a roughness less than 50 nm, was uniform and had no cracks or separations from the substrate.

What is claimed is:

1. A method for the densification of a porous metal oxide ceramic material comprising:
providing a solution of a metal-organic polymer wherein the solution comprises
from about 2 to about 20 percent by volume of the solution of a metal oxide
having the same composition as the porous metal oxide ceramic material;
treating the porous metal oxide ceramic material with the solution of the metal-organic polymer; and
heating the treated porous metal oxide ceramic material at a temperature of about
200° C. to about 800° C. to yield a densified metal oxide ceramic material.

2. The method of claim 1, wherein the metal oxide is selected from an oxide of aluminum, silicon, zirconium, cerium, titanium, yttrium, samarium, gadolinium, lanthanum, praseodymum, calcium, chromium, manganese, iron, cobalt, nickel, copper, niobium, hafnium, molybdenum, tantalum, tungsten and a mixture thereof.

3. The method of claim 1, wherein the treated porous metal oxide ceramic material is heated at a temperature of about 200° C. to about 500° C.

4. The method of claim 1, wherein the treated porous metal oxide ceramic material is heated at a temperature of about 200° C. to about 400° C.

5. A method for the preparation of a composite ceramic material comprising:
treating a porous metal oxide ceramic material with a solution of a metal-organic polymer, wherein;
the solution of a metal-organic polymer comprises from about 2 to about 20 percent by volume of the solution of a metal oxide having a different composition than the porous metal oxide ceramic material; and
heating the treated porous metal oxide ceramic material at a temperature of about
200° C. to about 800° C. to yield a composite metal oxide ceramic material.

6. The method of claim 5, wherein the porous metal oxide ceramic material is selected from an oxide of aluminum, silicon, zirconium, cerium, titanium, yttrium, samarium, gadolinium, lanthanum, praseodymum, calcium, chromium, manganese, iron, cobalt, nickel, copper, niobium, hafnium, molybdenum, tantalum, tungsten and a mixture thereof.

7. The method of claim 5, wherein the treated porous metal oxide ceramic material is heated at a temperature of about 200° C. to about 500° C.

8. The method of claim 7, wherein the treated porous metal oxide ceramic material is heated at a temperature of about 200° C. to about 400° C.

9. A method of preparing a metal oxide thin film on a substrate comprising:
preparing a suspension of a powdered metal oxide comprising
a metal oxide powder,
a solvent;
applying the suspension of the powdered metal oxide to a substrate to give a layer
of the metal oxide;
treating the layer of the metal oxide with a solution of a metal-organic polymer; and heat treatment at a temperature of about 200° C. to about 800° C. to give the metal oxide thin film.

10. The method of claim 9, wherein the powdered metal oxide is selected from an an oxide of aluminum, silicon, zirconium, cerium, titanium, yttrium, samarium, gadolinium, lanthanum, praseodymum, calcium, chromium, manganese, iron, cobalt, nickel, copper, niobium, hafnium, molybdenum, tantalum, tungsten and a mixture thereof.

11. The method of claim 9, wherein the heat treatment is at a temperature of about 200° C. to about 500° C.

12. The method of claim 11, wherein the heat treatment is at a temperature of about 200° C. to about 400° C.
